(19) United States
(12) Patent Application Publication
(10) Pub. No.: US 2015/0235656 A1
(43) Pub. Date: Aug. 20, 2015

(54) APPARATUS FOR DETECTING VOICE AND CONTROLLING METHOD THEREOF

(71) Applicant: SAMSUNG ELECTRO-MECHANICS CO., LTD., Gyeonggi-Do (KR)

(72) Inventor: Joo Hyun KIM, Gyeonggi-Do (KR)

(73) Assignee: SAMSUNG ELECTRO-MECHANICS CO., LTD., Gyeonggi-Do (KR)

(21) Appl. No.: 14/333,077

(22) Filed: Jul. 16, 2014

(30) Foreign Application Priority Data
Feb. 19, 2014 (KR) 10-2014-0019041

(51) Int. Cl. G10L 25/78; H04W 52/02

(52) U.S. Cl. CPC G10L 25/78; H04W 52/0251

(57) ABSTRACT

Embodiments of the invention provide a method and apparatus for detecting a voice. The apparatus, according to various embodiments of the invention, includes a driving signal processing unit configured to generate a driving signal using a first output voltage induced from an initial voice signal sensed by a piezoelectric and a first preset reference voltage. The apparatus, according to various embodiments of the invention, further includes a controlling unit configured to be turned-on only in the case in which the driving signal is applied from the driving signal processing unit to receive a voice signal from a microphone and determining whether or not a specific word is included in the voice signal.

### CROSS REFERENCE TO RELATED APPLICATION

This application claims the benefit of and priority under 35 U.S.C. §119 to Korean Patent Application No. KR 10-2014-0019041, entitled “APPARATUS FOR DETECTING VOICE AND CONTROLLING METHOD THEREOF,” filed on Feb. 19, 2014, which is hereby incorporated by reference in its entirety into this application.

### BACKGROUND

1. Field of the Invention

The present invention relates to an apparatus for detecting a voice and a controlling method thereof.

2. Description of the Related Art

In accordance with a recent development of a mobile communications technology, various communications services using a personal portable terminal have been studied and developed. Therefore, a function capable of performing a specific function of the person portable terminal using a voice input from a user has been generalized.

However, since an apparatus for recognizing a voice according to the conventional art as described, for example, in Korean Patent Application No. KR 10-2012-0088493, has a structure in which a microphone for recognizing the voice and a central processing unit (CPU) for analyzing and processing the voice recognized from the microphone always are turned-on and a standby state needs to be maintained, it may further consume power. Thus, this apparatus for recognizing the voice is not suitable for a mobile phone operated using a battery storing limited power.

### SUMMARY

Accordingly, embodiments of the invention have been made in an effort to provide an apparatus for detecting a voice driven only in a case in which case an initial voice signal of a use is present to detect a voice of the user, and a controlling method thereof.

According to an embodiment of the invention, there is provided an apparatus for detecting a voice. The apparatus includes a driving signal processing unit configured to generate a driving signal using a first output voltage induced from an initial voice signal sensed by a piezoelectric and a first preset reference voltage, and a controlling unit configured to be turned-on only in the case in which the driving signal is applied from the driving signal processing unit to receive a voice signal from a microphone and to determine whether or not a specific word is included in the voice signal.

According to an embodiment, when the driving signal is applied, the controlling unit is configured to vary the first reference voltage in the case in which the specific word is not detected from the voice signal for a predetermined time, and when the driving signal is not applied, the controlling unit is configured to compare the first reference voltage and a second reference voltage with each other at a predetermined period to vary the first reference voltage.

According to an embodiment, the driving signal processing unit includes an initial voice signal sensing module configured to amplify a voltage induced from the initial voice signal by the piezoelectric and to output the first output voltage, a driving signal generating module configured to compare the first output voltage and the first reference voltage with each other and to generate a driving signal in the case in which the first output voltage is larger than the first reference voltage, a register configured to store a first digitalized reference voltage therein, a second signal converting module configured to convert the first reference voltage input from the register into an analog form and to apply the converted first reference voltage to the driving signal generating module, and a first signal converting module configured to convert the first output voltage into a digital form and to apply the converted first output voltage to the controlling unit.

According to an embodiment, the driving signal generating module is a comparator having a non-inverting terminal (+) having the first output voltage applied thereto and an inverting terminal (−) having the first reference voltage applied thereto.

According to an embodiment, the initial voice signal sensing module includes a piezoelectric sensor including a piezoelectric configured to sense an initial voice signal generated from the outside and to output a voltage, and an amplifying module configured to amplify the voltage output from the piezoelectric by a predetermined gain and to output the first output voltage.

According to an embodiment, the controlling unit includes a controller configured to be turned-on only in the case in which the driving signal is applied from the driving signal generating module to receive the voice signal from the microphone and to determine whether or not the specific word is included in the voice signal, a first timer configured to start a counting for a time in the case in which the driving signal is applied and being initialized under a predetermined condition, and a second timer configured to start a counting for a time in the case in which the driving signal is not applied and being initialized under a predetermined condition.

According to an embodiment, when the driving signal is applied, the controller is configured to determine whether or not the specific word is included in the voice signal, and to increase the first reference voltage and to initialize the first timer in the case in which a counting value Time1 of the first timer is larger than a first preset reference time t₁, when the specific word is not included.

According to an embodiment, when the driving signal is not applied, the controller is further configured to compare the first reference voltage and a second reference voltage with each other in the case in which a counting value Time2 of the second timer is larger than a second preset reference time t₂, and to decrease the first reference voltage and to initialize the second timer in the case in which the first reference voltage is larger than the second reference voltage.

According to an embodiment, the first signal converting module is an analog-to-digital converter, and the second signal converting module is a digital-to-analog converter.

According to another embodiment of the invention, there is provided a controlling method of an apparatus for detecting a voice. The controlling method includes the steps of generating, by a driving signal processing unit, a driving signal using a first output voltage induced from an initial voice signal by a piezoelectric and a first preset reference voltage, and turning-on a controlling unit only in the case in which the driving signal is applied from the driving signal processing unit to receive a voice signal from a microphone and determining whether or not a specific word is included in the voice signal.

According to an embodiment, the controlling method further includes the step of varying, by the controlling unit, the first reference voltage in the case in which the specific word is not detected from the voice signal, when the driving signal is applied for a predetermined time, and comparing, by the controlling unit, the first reference voltage and a second reference voltage with each other at a predetermined period to vary the first reference voltage, when the driving signal is not applied.

According to an embodiment, the generating of the driving signal includes amplifying, by an initial voice signal sensing module, a voltage induced from the initial voice signal by the piezoelectric and outputting the first output voltage, converting, by a second signal converting module, the first reference voltage input from a register into an analog form and applying the converted first reference voltage to a driving signal generating module, comparing, by the driving signal generating module, the first output voltage and the first reference voltage with each other and generating a driving signal in the case in which the first output voltage is larger than the first reference voltage, and converting, by a first signal converting module, the first output voltage into a digital form and applying the converted first output voltage to the controlling unit.

According to an embodiment, the controlling method further includes determining whether or not a specific word is included in the voice signal in the case in which the driving signal is applied to a controller, comparing a counting value Time1 of a first timer with a first preset reference time t₁ in the case in which the specific word is not included, and increasing the first reference voltage and initializing the first timer in the case in which the counting value Time1 of the first timer is larger than the first preset reference time t₁.

According to an embodiment, the controlling method further includes comparing a counting value Time2 of a second timer with a second preset reference time t₂ in the case in which the driving signal is not applied to the controller, and decreasing the first reference voltage and initializing the second timer in the case in which the first reference voltage is larger than the second reference voltage when a counting value Time2 of the second timer is larger than a second preset reference time t₂.

According to an embodiment, the driving signal generating module is a comparator having a non-inverting terminal (+) having the first output voltage applied thereto and an inverting terminal (−) having the first reference voltage applied thereto.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram for an apparatus for detecting a voice according to an embodiment of the invention.

FIG. 2 is a circuit diagram for the apparatus for detecting the voice according to an embodiment of the invention.

FIG. 3 is a flow chart showing a controlling method of an apparatus for detecting a voice according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

Hereinafter, an apparatus for detecting a voice and a controlling method thereof according to various embodiments of the present invention will be described in detail with reference to the accompanying drawings.

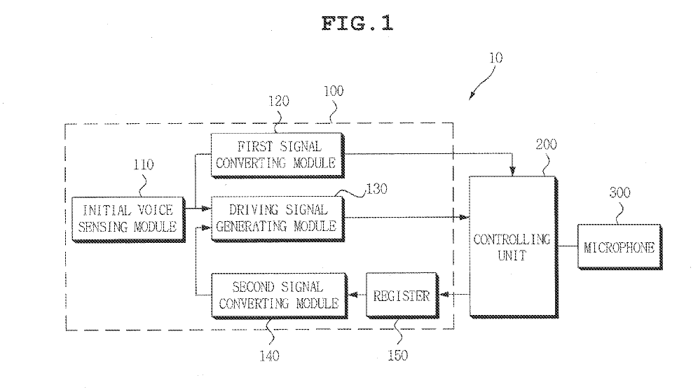

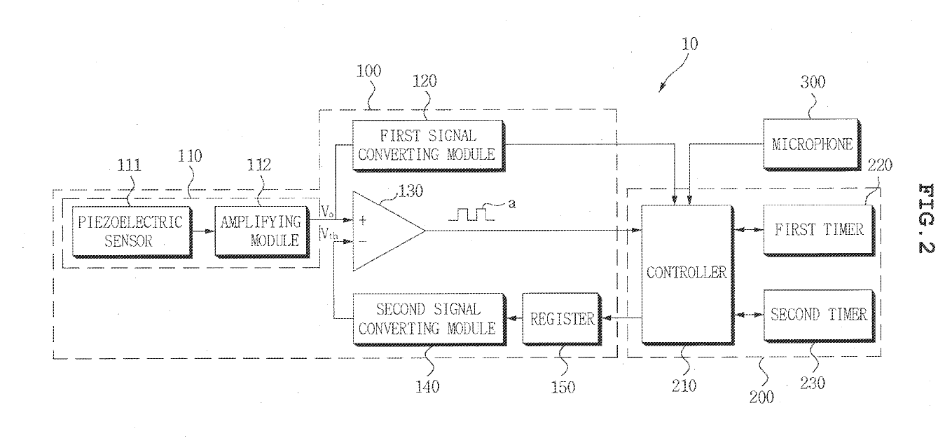

FIG. 1 is a block diagram for an apparatus for detecting a voice according to an embodiment of the invention, and FIG. 2 is a circuit diagram for the apparatus for detecting the voice according to an embodiment of the invention.

As shown in FIGS. 1 and 2, an apparatus 10 for detecting a voice, according to an embodiment of the invention, includes a driving signal processing unit or processor 100 generating a driving signal using a voltage induced from an initial voice signal of a user through a piezoelectric sensor 111 including a piezoelectric and a controlling unit or controller 200 performing a voice recognition function of the user by the driving signal.

According to an embodiment, the driving signal processing unit 100 generates a driving signal a using a first output voltage Vₒ induced from the initial voice signal sensed by the piezoelectric and a first preset reference voltage Vₜₕ, and includes an initial voice signal sensing module 110, a driving signal generating module 130, a register 150, a second signal converting module 140, and a first signal converting module 120.

According to an embodiment, the initial voice signal sensing module 110 amplifies the voltage induced from the initial voice signal by the piezoelectric to output the first output voltage Vₒ and includes a piezoelectric sensor 111 formed of the piezoelectric generating a voltage by an external pressure and an amplifying module 112 amplifying the voltage by a predetermined gain to output the first output voltage VO. According to an embodiment, the piezoelectric sensor 111 is provided in a front glass or a case of a smart phone, as non-limiting examples.

According to an embodiment, the driving signal generating module 130 compares the first output voltage Vₒ output from the amplifying module and the first reference voltage Vₜₕ with each other to generate the driving signal a and apply the driving signal a to the controlling unit 200. According to an embodiment, the driving signal generating module 130 includes a comparator having a non-inverting terminal (+) having the first output voltage Vₒ applied thereto and an inverting terminal (−) having the first reference voltage Vₜₕ applied thereto, wherein the comparator outputs the driving signal a having a pulse shape when the first output voltage Vₒ is larger than the first reference voltage Vₜₕ.

According to an embodiment, the register 150 stores a first digitalized reference voltage Vₜₕ and transfers the first reference voltage Vₜₕ to the driving signal generating module 130, when the first output voltage Vₒ is input to the driving signal generating module 130, wherein the first reference voltage Vₜₕ is changed by the controlling unit 200 depending on a degree of a surrounding noise. According to an embodiment, the register 150 is configured by a flip-flop or latch circuit.

According to an embodiment, the first signal converting module 120 converts the first output voltage Vₒ of an analog form from the driving signal generating module 130 into a digital form and then transfers it to the controlling unit 200, and the second signal converting module 140 converts the first digitalized reference voltage Vₜₕ stored in the register 150 into the analog form and transfers it to the driving signal generating module 130. According to an embodiment, the first signal converting module 120 is an analog-to-digital converter and the second signal converting module 140 is a digital-to-analog converter.

According to an embodiment, the controlling unit 200 is turned-on only in the case in which the driving signal a is applied from the driving signal processing unit 100 to receive the voice signal from the microphone 300, determines whether or not a specific word is included in the voice signal, and performs an application, as non-limiting examples, corresponding to the specific word when the specific word is sensed.

Further, according to an embodiment, the controlling unit 200 varies the first reference voltage Vₜₕ in the case in which the specific word is not detected from the voice signal during a predetermine time when the driving signal is applied from the driving signal generating module 130 (i.e., the first output voltage Vₒ is larger than the first reference voltage Vₜₕ) and compares the first reference voltage Vₜₕ and a second reference voltage V_{MIN} with each other at a predetermined period, when the driving signal is not applied (the first output voltage Vₒ is smaller than the first reference voltage Vₜₕ) to vary the first reference voltage Vₜₕ.

In addition, according to an embodiment, the controlling unit 200 is turned-on only in the case in which the driving signal a is applied from the driving signal processing unit 130 to receive the voice signal from the microphone 300, and includes a controller 210 determining whether or not a specific word is included in the voice signal, a first timer 220 starting a counting for time in the case in which the driving signal a is applied and initialized under a predetermined condition, and a second timer 230 starting a counting for time in the case in which the driving signal a is not applied and initialized under a predetermined condition.

According to an embodiment, the controller 210 determines whether or not the specific word is included in the voice signal when the driving signal a is applied, and increases the first reference voltage Vₜₕ (Vₜₕ+C, here C is an experimental value) and initializes the first timer 220 in the case in which a counting value Time 1 of the first timer 220 is larger than a first preset reference time t₁ when the specific word is not included in the voice signal.

In addition, according to an embodiment, the controller 210 compares the first reference value Vₜₕ and the second reference value V_{MIN} with each other in the case in which a counting value Time 2 of the second timer 230 is larger than a second preset reference time t₂ when the driving signal a is not applied, and decreases the first reference voltage Vₜₕ (Vₜₕ−C, here C is an experimental value) and initializes the second timer 230 in the case in which the first reference voltage Vₜₕ is larger than the second reference voltage V_{MIN}.

As described above, in the driving signal processing unit of the apparatus for detecting the voice according to an embodiment of the invention, since the piezoelectric sensor is vibrated by the initial voice of the external user and only in the case in which the driving signal generated by using the voltage output from the piezoelectric sensor and the preset reference voltage is applied to the controlling unit (e.g., the CPU), the controlling unit performs the voice recognition of the user through the selective driving performing the external voice recognition by the microphone, the consumption power is significantly decreased as compared with the case in which, for example, the controlling unit is always on standby in the turn-on state for recognizing the voice of the user according to the conventional art.

In addition, the controlling unit of the apparatus for detecting the voice according to an embodiment of the invention prevents malfunctions of the voice recognition function of the user caused by the magnitude change of the noise according to the change of the surrounding environment by the adaptive driving that the reference voltage is varied and applied under the predetermined reference according to the magnitude change of the surrounding noise, thereby making it possible to secure accuracy of the voice recognition by the apparatus for detecting the voice.

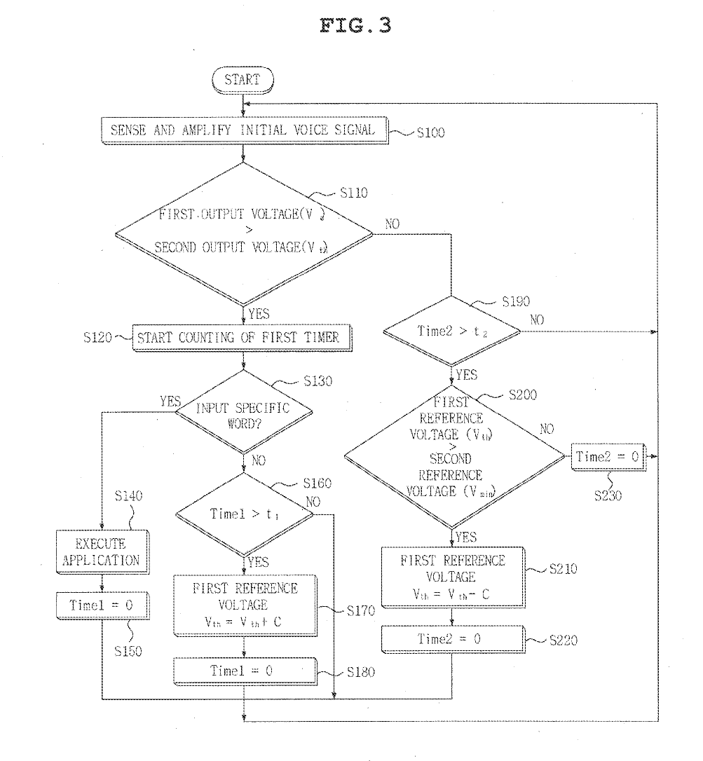

Hereinafter, a controlling method of an apparatus for detecting a voice according to various embodiments of the invention will be described in detail with reference to FIG. 3.

FIG. 3 is a flow chart showing a controlling method of an apparatus for detecting a voice according to an embodiment of the invention. As shown in FIG. 3, in the controlling method of the apparatus for detecting the voice according to an embodiment of the invention, when the initial voice signal is uttered by the user, the initial voice signal vibrates the piezoelectric sensor 111, wherein the piezoelectric sensor 111 outputs a voltage corresponding to the vibration, and the amplifying module 112 amplifies the voltage by a predetermined gain and output the first output voltage Vₒ (S100).

Next, according to an embodiment, the driving signal generating module 130 compares the first output voltage Vₒ input from the amplifying module 112 with the first preset reference voltage Vₜₕ and generates the driving signal a, which is a pulse wave (square wave), and applies it to the controlling unit 200 only in the case in which the first output voltage Vₒ is larger than the first reference voltage Vₜₕ (S110). According to an embodiment, the register 150 converts the first digitalized reference voltage Vₜₕ into the analog form using the second signal converting module 140 and provides it to the driving signal generating module 130, even in the case in which the controlling unit 200 is in a state before it is driven.

In addition, according to an embodiment, the controlling unit 200 starts a counting of the first timer 220 (S120) and is turned-on only in the case in which the driving signal a is input from the driving signal generating module 130, senses the voice signal of the user by the microphone 300, and determines whether or not the specific word is included in the voice signal (S130).

Next, according to an embodiment, the controlling unit 200 executes, for example, an application corresponding to the specific word (S140) and initializes the counting value Time1 of the first timer 220 (S150), when it is determined that the specific word is included in the voice signal.

In addition, according to an embodiment, the controlling unit 200 compares the counting value Time1 of the first timer 220 with the first referent time t₁, when the specific word is not included and determines that a voltage larger than the first reference voltage Vₜₕ is generated due to the piezoelectric sensor 111 vibrated by the surrounding noise, when the counting value Time1 is larger than the first reference time t₁ to add a predetermined constant C to the first reference voltage Vₜₕ (S170) and initializes the first timer 220 (S180). According to an embodiment, the predetermined constant C is an experimental value taking account of the surrounding noise, and the first reference time t₁ is set to 2 seconds, but is not limited thereto.

Further, according to an embodiment, the controlling unit 200 compares a counting value Time2 of the second timer with the second reference time t₂, when the driving signal a is not applied from the driving signal generating module 130 due to the first output voltage Vₒ smaller than the first reference voltage Vₜₕ (S190) and compares the first reference voltage Vₜₕ with the second reference voltage V_{MIN}, when the counting value Time2 is larger than the second reference time t₂ (S200). According to an embodiment, the second reference voltage V_{MIN} refers to a minimum voltage, which is the first reference voltage Vₜₕ.

In addition, according to an embodiment, the controlling unit 200 determines that an environment is changed from an environment having a loud surrounding noise to a quiet environment, when the first reference voltage Vₜₕ is larger than the second reference voltage V_{MIN} to thereby subtract the predetermined constant C from the first reference voltage Vₜₕ (S210) and initializes the second timer 230 (S220). According to an embodiment, in the case in which the first reference voltage Vₜₕ is smaller than the second reference voltage V_{MIN}, the second time 230 is initialized (S230).

In the driving signal processing unit of the apparatus for detecting the voice according to an embodiment of the invention, since the piezoelectric sensor is vibrated by the initial voice of the external user and only in the case in which the driving signal generated by using the voltage output from the piezoelectric sensor and the preset reference voltage is applied to the controlling unit (e.g., CPU), the controlling unit performs the voice recognition of the user through the selective driving performing the external voice recognition by the microphone, the consumption power is significantly decreased as compared with the case in which the controlling unit is always on standby in the turn-on state for recognizing the voice of the user according to the conventional art.

In addition, according to an embodiment, the controlling unit of the apparatus for detecting the voice according to an embodiment invention prevents malfunctions of the voice recognition function of the user caused by the magnitude change of the noise according to the change of the surrounding environment by the adaptive driving that the reference voltage is varied and applied under the predetermined reference according to the magnitude change of the surrounding noise, thereby making it possible to secure accuracy of the voice recognition by the apparatus for detecting the voice.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An apparatus for detecting a voice, the apparatus comprising:
a driving signal processing unit configured to generate a driving signal using a first output voltage induced from an initial voice signal sensed by a piezoelectric and a first preset reference voltage; and
a controlling unit configured to be turned-on only in the case in which the driving signal is applied from the driving signal processing unit to receive a voice signal from a microphone and determining whether or not a specific word is included in the voice signal.

2. The apparatus for detecting the voice as set forth in claim 1, wherein, when the driving signal is applied, the controlling unit is configured to vary the first reference voltage in the case in which the specific word is not detected from the voice signal for a predetermined time, and, when the driving signal is not applied, the controlling unit is configured to compare the first reference voltage and a second reference voltage with each other at a predetermined period to vary the first reference voltage.

3. The apparatus for detecting the voice as set forth in claim 1, wherein the driving signal processing unit comprises:
an initial voice signal sensing module configured to amplify a voltage induced from the initial voice signal by the piezoelectric and output the first output voltage;
a driving signal generating module configured to amplify compare the first output voltage and the first reference voltage with each other and to generate a driving signal in the case in which the first output voltage is larger than the first reference voltage;
a register configured to store a first digitalized reference voltage therein;
a second signal converting module configured to convert the first reference voltage input from the register into an analog form and to apply the converted first reference voltage to the driving signal generating module; and
a first signal converting module configured to convert the first output voltage into a digital form and to apply the converted first output voltage to the controlling unit.

4. The apparatus for detecting the voice as set forth in claim 3, wherein the driving signal generating module is a comparator having a non-inverting terminal (+) having the first output voltage applied thereto and an inverting terminal (−) having the first reference voltage applied thereto.

5. The apparatus for detecting the voice as set forth in claim 3, wherein the initial voice signal sensing module comprises:
a piezoelectric sensor comprising a piezoelectric configured to sense an initial voice signal generated from the outside and to output a voltage; and
an amplifying module configured to amplify the voltage output from the piezoelectric by a predetermined gain and to output the first output voltage.

6. The apparatus for detecting the voice as set forth in claim 3, wherein the controlling unit comprises:
a controller configured to be turned-on only in the case in which the driving signal is applied from the driving signal generating module to receive the voice signal from the microphone and to determine whether or not the specific word is included in the voice signal;
a first timer configured to start a counting for a time in the case in which the driving signal is applied and being initialized under a predetermined condition; and
a second timer configured to start a counting for a time in the case in which the driving signal is not applied and being initialized under a predetermined condition.

7. The apparatus for detecting the voice as set forth in claim 6, wherein, when the driving signal is applied, the controller is further configured to determine whether or not the specific word is included in the voice signal and to increase the first reference voltage and to initialize the first timer in the case in which a counting value Time1 of the first timer is larger than a first preset reference time t₁, when the specific word is not included.

8. The apparatus for detecting the voice as set forth in claim 7, wherein when the driving signal is not applied, the controller is further configured to compare the first reference voltage and a second reference voltage with each other in the case in which a counting value Time2 of the second timer is larger than a second preset reference time t₂, and to decrease the first reference voltage and to initialize the second timer in the case in which the first reference voltage is larger than the second reference voltage.

9. The apparatus for detecting the voice as set forth in claim 3, wherein the first signal converting module is an analog-to-digital converter, and the second signal converting module is a digital-to-analog converter.

10. A controlling method of an apparatus for detecting a voice, the controlling method comprising:
generating, by a driving signal processing unit, a driving signal using a first output voltage induced from an initial voice signal by a piezoelectric and a first preset reference voltage; and
turning-on a controlling unit only in the case in which the driving signal is applied from the driving signal processing unit to receive a voice signal from a microphone and determining whether or not a specific word is included in the voice signal.

11. The controlling method as set forth in claim 10, further comprising:
varying, by the controlling unit, the first reference voltage in the case in which the specific word is not detected from the voice signal for a predetermined time when the driving signal is applied, and
comparing, by the controlling unit, the first reference voltage and a second reference voltage with each other at a predetermined period to vary the first reference voltage when the driving signal is not applied.

12. The controlling method as set forth in claim 10, wherein the generating of the driving signal comprises:
amplifying, by an initial voice signal sensing module, a voltage induced from the initial voice signal by the piezoelectric and outputting the first output voltage;
converting, by a second signal converting module, the first reference voltage input from a register into an analog form and applying the converted first reference voltage to a driving signal generating module;
comparing, by the driving signal generating module, the first output voltage and the first reference voltage with each other and generating a driving signal in the case in which the first output voltage is larger than the first reference voltage; and
converting, by a first signal converting module, the first output voltage into a digital form and applying the converted first output voltage to the controlling unit.

13. The controlling method as set forth in claim 12, further comprising:
determining whether or not a specific word is included in the voice signal in the case in which the driving signal is applied to a controller;
comparing a counting value Time1 of a first timer with a first preset reference time t₁ in the case in which the specific word is not included; and
increasing the first reference voltage and initializing the first timer in the case in which the counting value Time1 of the first timer is larger than the first preset reference time t₁.

14. The controlling method as set forth in claim 13, further comprising:
comparing a counting value Time2 of a second timer with a second preset reference time t₂ in the case in which the driving signal is not applied to the controller; and
decreasing the first reference voltage and initializing the second timer in the case in which the first reference voltage is larger than the second reference voltage when a counting value Time2 of the second timer is larger than a second preset reference time t₂.

15. The controlling method as set forth in claim 12, wherein the driving signal generating module is a comparator having a non-inverting terminal (+) having the first output voltage applied thereto and an inverting terminal (−) having the first reference voltage applied thereto.
